(19) United States
(12) Patent Application Publication
(10) Pub. No.: US 2004/0082206 A1
(43) Pub. Date: Apr. 29, 2004

(54) Gigabit interface converter housing

(75) Inventors: Chia-Hsiung Chang, Hsinchu (TW); Hong-Jueng King, Hsinchu (TW); Huei-Pin Huang, Hsinchu (TW); Chwei-Jing Yeh, Hsinchu (TW)

Correspondence Address: BACON & THOMAS, PLLC, 625 SLATERS LANE, FOURTH FLOOR, ALEXANDRIA, VA, 22314

(73) Assignee: RiTek Corporation, Hsinchu (TW)

(21) Appl. No.: 10/614,093

(22) Filed: Jul. 8, 2003

(30) Foreign Application Priority Data
Oct. 25, 2002 (TW) 91217197

(51) Int. Cl. H01R 12/00

(52) U.S. Cl. 439/76.1

(57) ABSTRACT

A sturdy parallelepiped housing includes a base including a plurality of spaces with a gigabit interface converter (GBIC) placed in one of the spaces and a plurality of stoppers are fitted against the GBIC; and a cover including a plurality of risers urging against walls in the base. A plurality of threaded holes is further formed in each of the base and the cover so that the housing can be fastened together by fasteners.

### BACKGROUND OF THE INVENTION

1. Field of the Invention

The present invention relates to housing structure of an electronic device and, more particularly, to a gigabit interface converter (GBIC) housing with enhanced structural strength.

2. Description of Related Art

Conventionally, an optoelectronic transceiver (e.g., a gigabit optoelectronic transceiver) module is implemented for transmitting and receiving data in duplex in an optical communication environment. The gigabit optoelectronic transceiver module comprises a connector, a conversion circuit, a laser source, and a light detector. The connector is coupled to a host or computer. Data received from the host or computer is converted into an optical signal by the conversion circuit and the laser source prior to outputting. Alternatively, the optical signal is received by the light detector prior to converting it into an electronic signal. Finally, the electronic signal is sent to the host or computer via the connector.

For having a prolonged lifetime for application, in addition to an advanced circuitry, the gigabit optoelectronic transceiver module should have an enhanced housing capable of passing impact and stress tests. However, no prior art gigabit optoelectronic transceiver module has such a desired housing. Therefore, it is desirable to provide an improved gigabit interface converter housing in order to mitigate and/or obviate the aforementioned problem.

### SUMMARY OF THE INVENTION

An object of the present invention is to provide a gigabit interface converter housing which is sturdy enough to withstand a strong impact.

In one aspect of the present invention, there is provided a parallelepiped housing for enclosing a gigabit interface converter (GBIC) including a printed circuit board, a laser source, a light detector, and a connecter wherein one end of each of the laser source and the light detector is coupled to a first end of the printed circuit board and the connecter is formed at a second end opposite to the first end of the printed circuit board, the housing comprising: a base having a first spacer, a first space, a second space and a third space, wherein the first space has a first stopper and a second stopper for positioning the printed circuit board and for being fitted against the connecter therebetween, the second space is adapted for positioning the laser source, the third space is adapted for positioning the light detector, the first spacer is adapted for separating the second and the third spaces, and the first spacer having a first fastener for fastening the printed circuit board; and a cover, having a first protrusion and a second protrusion for being fitted against the connector of the GBIC.

In another aspect of the present invention, there is also provided a gigabit interface converter (GBIC) including: an interface having a printed circuit board, a laser source, a light detector, and a connecter wherein one end of each of the laser source and the light detector is coupled to a first end of the printed circuit board and the connecter is formed at a second end opposite to the first end of the printed circuit board; wherein the first space has a first stopper and a second stopper for positioning the printed circuit board and for being fitted against the connecter therebetween, the second space is adapted for positioning the laser source, the third space is adapted for positioning the light detector, the first spacer is adapted for separating the second and the third spaces, and the first spacer having a first fastener for fastening the printed circuit board; and a cover, having a first protrusion and a second protrusion for being fitted against the connector.

Other objects, advantages, and novel features of the invention will become more apparent from the detailed description when taken in conjunction with the accompanying drawings.

### BRIEF DESCRIPTION OF THE DRAWINGS

FIG. 1 is an exploded view of a preferred embodiment of gigabit interface converter (GBIC) housing according to the invention; and

FIG. 2 is a cross-sectional view of the assembled GBIC housing.

### DETAILED DESCRIPTION OF THE PREFERRED EMBODIMENT

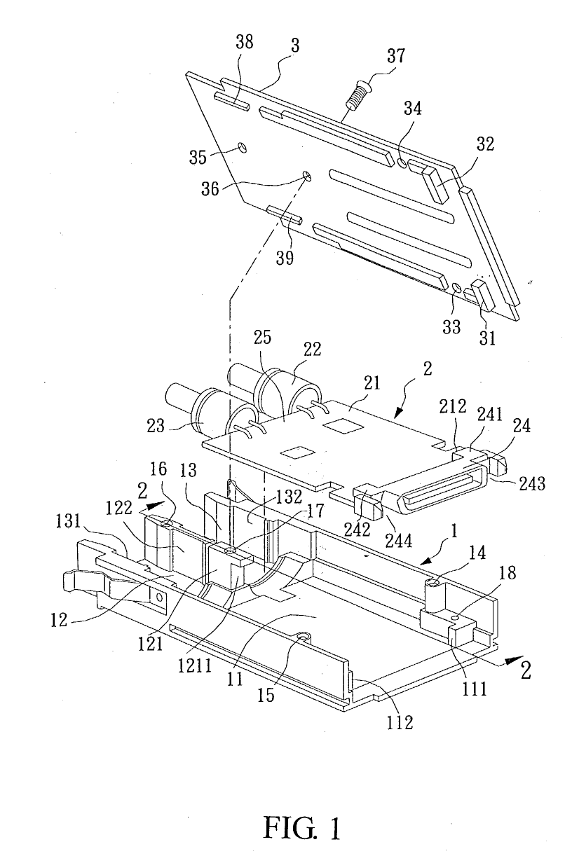

With reference to FIG. 1, there is shown a gigabit interface converter (GBIC) 2 enclosed in a parallelepiped sturdy housing consisting of a cover 3 and a base 1 in accordance with the invention. Each of the GBIC 2, the cover 3, and the base 1 has a substantially rectangular shape and each of them is described in detail below.

The base 1 comprises a plurality of spaces consisting of first, second, and third spaces 11, 12, and 13. The first space 11 is at a forward portion of the base 1 and the second and third spaces 12 and 13 are at a rear portion thereof. First and second spacers 121 and 122 are provided between the second and third spaces 12 and 13. Preferably, the first and second spacers 121 and 122 are adjacent but not coupled together, i.e., there is a gap between them. A fastener 1211 is formed at a forward side of the first spacer 121 facing the first space 11.

The GBIC 2 comprises a printed circuit board 21, a laser source 22, a light detector 23, and a connecter 24. There are many integrated circuits (ICs) and passive elements on the printed circuit board 21 for providing an optical-to-electrical or an electrical-to-optical conversion. Preferably, the laser source 22 is a laser diode and the light detector 23 is a light detection diode respectively. One end of each of the laser source 22 and the light detector 23 is coupled to one end of the printed circuit board 21 and the other ends thereof are coupled to an optical fiber (not shown) for transmitting or receiving optical signals thereto/from. The connecter 24 is formed at the other end of the printed circuit board 21 for coupling to a mating connector of a host or computer (not shown). The connecter 24 is a D type connector. The connecter 24 includes a first upward protrusion 241, a second upward protrusion 242, a first downward protrusion 243 and a second downward protrusion 244. The first upward protrusion 241 and the second upward protrusion 242 contact the surface of the printed circuit board 21, and the downward protrusion 243 and the downward protrusion 244 contact the back of the printed circuit board 21 so as to protect the connection part that the internal pins of the connecter 24 are connected to the printed circuit board 21.

The GBIC 2 is positioned on the base 1 in which both the printed circuit board 21 and the connecter 24 are placed in the first space 11, the laser source 22 is placed in the third space 13, and the light detector 23 is placed in the second space 12 respectively. There is a first spacer 121 between the laser source 22 and the light detector 23. The fastener 1211 of the first spacer 121 uses for fastening the fastener part 25 of the printed circuit board 21. It is envisaged that the printed circuit board 21 will not be damaged when a strong external force is suddenly applied on the connecter 24 which is exposed to the outside.

The base 1 at its two front corners further comprises a first stopper 111 urged against the first downward protrusion 243 and a second stopper 112 urged against the second downward protrusion 244 so as to position the GBIC 2. Hence, the engagement portion of the pins of the connecter 24 with the printed circuit board 21 can be further protected.

The cover 3 at its inner surface has a first protrusion 31, a second protrusion 32, a second fastener 38 and a third fastener 39. The first protrusion 31 is fitted against the first upward protrusion 241 of the connecter 24, the second protrusion 32 is fitted against the second upward protrusion 242 of the connecter 24. There is a first fastening wall 131 in the second space 12, and there is a second fastening wall 132 in the third space 13. Wherein the first fastening wall 131 uses for fastening the second fastener 38 of the cover 3, and the second fastening wall 132 uses for fastening the third fastener 39 of the cover 3.

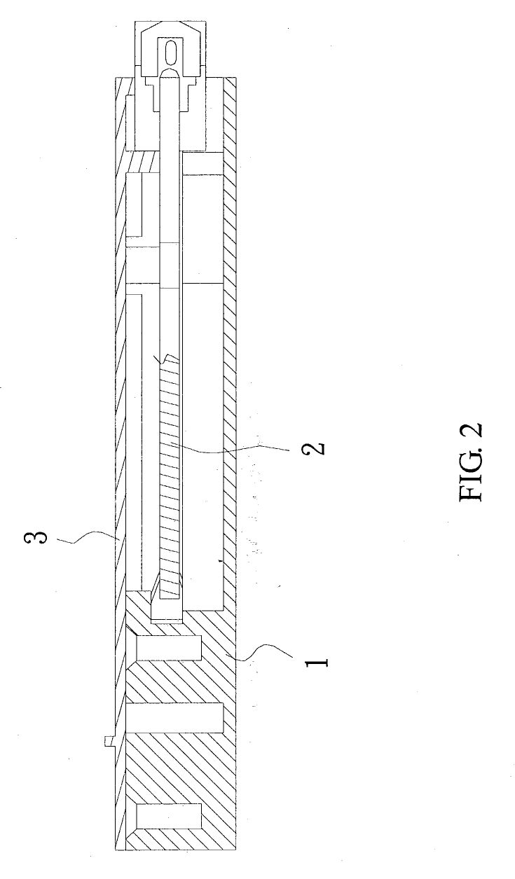

The base 1 further comprises a plurality of screw holes 14, 15, 16, 17, and 18. The cover 3 further comprises a plurality of threaded holes 33, 34, 35, and 36. The GBIC 2 further comprises a threaded hole 212. Hence, a plurality of screws (only one is shown) 37 can be used to fasten the cover 3, the GBIC 2, and the base 1 together. In detail, four screws are driven through the pair of threaded/screw holes 35 and 16, the pair of threaded/screw holes 36 and 17, the pair of threaded/screw holes 33 and 14, and the pair of threaded/screw holes 34 and 15 respectively while one screw is driven through the pair of threaded holes 18 and 212. It is appreciated that the number of the pairs of threaded/screw holes can be increased or decreased in other applications. The assembled GBIC 2, cover 3, and base 1 is shown in a cross-sectional view of FIG. 2.

In brief, the invention utilizes a housing that positions a GBIC, the housing includes a cover and a base, wherein the cover or the base has a plurality of protrusions, a plurality of fasteners and a plurality of fastening walls so as to fasten or be fitted against the GBIC in order to withstand a strong impact.

Although the present invention has been explained in relation to its preferred embodiment, it is to be understood that many other possible modifications and variations can be made without departing from the spirit and scope of the invention as hereinafter claimed.

What is claimed is:

1. A parallelepiped housing for enclosing a gigabit interface converter (GBIC) including a printed circuit board, a laser source, a light detector, and a connecter wherein one end of each of the laser source and the light detector is coupled to a first end of the printed circuit board and the connecter is formed at a second end opposite to the first end of the printed circuit board, the housing comprising:
a base having a first spacer, a first space, a second space and a third space, wherein the first space has a first stopper and a second stopper for positioning the printed circuit board and for being fitted against the connecter therebetween, the second space is adapted for positioning the laser source, the third space is adapted for positioning the light detector, the first spacer is adapted for separating the second and the third spaces, and the first spacer having a first fastener for fastening the printed circuit board; and
a cover having a first protrusion and a second protrusion for being fitted against the connector of the GBIC.

2. The housing as claimed in claim 1, wherein the base further comprises a second spacer for separating the second and the third spaces.

3. The housing as claimed in claim 1, wherein the base further comprises at least one junction unit, the cover further comprises at least one hole each disposed corresponding to the junction unit of the base.

4. The housing as claimed in claim 3, wherein each of the junction units is a screw hole.

5. The housing as claimed in claim 4, wherein the printed circuit board has at least one threaded hole each disposed corresponding to one of the junction units of the base.

6. The housing as claimed in claim 1, wherein the base further has a first fastening wall and a second fastening wall.

7. The housing as claimed in claim 6, wherein the cover further comprises a second fastener and a third fastener, the second fastener fastens the first fastening wall together, and the third fastener fastens the second fastening wall together.

8. A gigabit interface converter (GBIC), comprising:
an interface having a printed circuit board, a laser source, a light detector, and a connecter; wherein one end of each of the laser source and the light detector is coupled to a first end of the printed circuit board and the connecter is formed at a second end opposite to the first end of the printed circuit board;
a base having a first spacer, a first space, a second space and a third space, wherein the first space has a first stopper and a second stopper for positioning the printed circuit board and for being fitted against the connecter therebetween, the second space is adapted for positioning the laser source, the third space is adapted for positioning the light detector, the first spacer is adapted for separating the second and the third spaces, and the first spacer having a first fastener for fastening the printed circuit board; and
a cover having a first protrusion and a second protrusion for being fitted against the connector.

9. The gigabit interface converter as claimed in claim 8, wherein the base further comprises a second spacer for separating the second and the third spaces.

10. The gigabit interface converter as claimed in claim 8, wherein the base further comprises at least one junction unit, the cover further comprises at least one hole each disposed corresponding to the junction unit of the base.

11. The gigabit interface converter as claimed in claim 8, wherein each of the junction units is a screw hole.

12. The gigabit interface converter as claimed in claim 8, wherein the base further has a first fastening wall and a second fastening wall.

13. The gigabit interface converter as claimed in claim 8, wherein the cover further comprises a second fastener and a third fastener, the second fastener fastens the first fastening wall together, and the third fastener fastens the second fastening wall together.
